(19) United States
(12) Patent Application Publication
(10) Pub. No.: US 2018/0276301 A1
(43) Pub. Date: Sep. 27, 2018

(54) SYSTEM AND METHOD FOR TYPE-SPECIFIC ANSWER FILTERING FOR NUMERIC QUESTIONS

(71) Applicant: International Business Machines Corporation, Armonk, NY (US)

(72) Inventors: Charles E. Beller, Baltimore, MD (US); Sean L. Bethard, Centreville, VA (US); Edward G. Katz, Washington, DC (US)

(21) Appl. No.: 15/467,280

(22) Filed: Mar. 23, 2017

(51) Int. Cl. G06F 17/30

(52) U.S. Cl. CPC G06F 17/30867; G06F 17/3043

(57) ABSTRACT

Embodiments can provide a computer implemented method in a data processing system comprising a processor and a memory comprising instructions which are executed by the processor to cause the processor to implement a type-specific answer filtration system, the method comprising parsing, by the processor, one or more input questions; for each input question: attempting, by a number-subtype finder module, to identify one or more number-subtype head-nouns; attempting, by a number-subtype finder module, to identify one or more number-subtype verbs; attempting, by a number-subtype finder module, to identify one or more number-subtype adjectives; based on the presence of at least one number-subtype head-noun, number-subtype verb, or number-subtype adjective, determining, by a question classifier module, the number-subtype of the input questions; labelling the input question with the determined number-subtype; iterating through one or more answer candidates associated with the input question; for each answer candidate, determining, by an answer candidate classifier module, the number-subtype of the answer candidate; and if the answer candidate number-subtype does not match the input question number-subtype, removing, by an answer candidate removal module, the answer candidate.

### STATEMENT REGARDING FEDERALLY SPONSORED RESEARCH OR DEVELOPMENT

This invention was made with government support under contract number 2013-12101100008 awarded by United States defense agencies. The government has certain rights to this invention.

### TECHNICAL FIELD

The present application relates generally to a system and method that can be used to correctly identify the type of numerical answer that is appropriate for a particular question.

### BACKGROUND

Identifying the semantic type of an appropriate answer to a question is one of the fundamental tasks of an automatic question answering system, such as the Watson Discovery Advisor (WDA). WDA incorporates coarse grained question classification as a part of its deep question and answer technology, distinguishing number questions, date questions, and factoid questions. These course-grained types in-part can determine which answer generators are applied and how answers are scored. Detailed information about the subtype of the sought answer can play an indirect role in the scoring, but in practice can mean that errors are often embarrassingly bad—not just the wrong answer being delivered by the system, but the entirely wrong type of answer. For example, a question such as “How long did it take to build the Great Wall of China?” might result in an answer such as “3,889 miles” being generated.

### SUMMARY

Embodiments can provide a computer implemented method, in a data processing system comprising a processor and a memory comprising instructions which are executed by the processor to cause the processor to implement a type-specific answer filtration system, the method comprising parsing, by the processor, one or more input questions; for each input question: attempting, by a number-subtype finder module, to identify one or more number-subtype head-nouns; attempting, by a number-subtype finder module, to identify one or more number-subtype verbs; attempting, by a number-subtype finder module, to identify one or more number-subtype adjectives; based on the presence of at least one number-subtype head-noun, number-subtype verb, or number-subtype adjective, determining, by a question classifier module, the number-subtype of the input questions; labelling the input question with the determined number-subtype; iterating through one or more answer candidates associated with the input question; for each answer candidate, determining, by an answer candidate classifier module, the number-subtype of the answer candidate; and if the answer candidate number-subtype does not match the input question number-subtype, removing, by an answer candidate removal module, the answer candidate.

Embodiments can further provide a method further comprising attempting to identify one or more number-subtype head nouns from at least one of the lexical answer type, the non-lexical answer type head-noun of a Wh-noun-phrase, a subordinate noun to a transparent nominal predicate, a noun complemental of a prepositional phrase, or a noun that is an argument to a verb.

Embodiments can further provide a method further comprising attempting to identify one or more number-subtype head-nouns using a prepopulated list of noun-subtypes.

Embodiments can further provide a method further comprising attempting to identify the one or more number subtype verbs from at least one of a root verb of the input question or a subordinate verb underneath a transparent verbal predicate.

Embodiments can further provide a method further comprising attempting to identify the one or more number-subtype verbs using a prepopulated list of verb-subtypes.

Embodiments can further provide a method further comprising attempting to identify one or more number-subtype adjectives using a prepopulated list of adjective-subtypes.

Embodiments can further provide a method further comprising determining a set of compatible number-subtypes based upon one or more mappings of at least one of the identified head-noun, identified verb, or identified adjective.

In another illustrative embodiment, a computer program product comprising a computer usable or readable medium having a computer readable program is provided. The computer readable program, when executed on a processor, causes the processor to perform various ones of, and combinations of, the operations outlined above with regard to the method illustrative embodiment.

In yet another illustrative embodiment, a system is provided. The system may comprise a type-specific answer filtration processor configured to perform various ones of, and combinations of, the operations outlined above with regard to the method illustrative embodiment.

Additional features and advantages of this disclosure will be made apparent from the following detailed description of illustrative embodiments that proceeds with reference to the accompanying drawings.

### BRIEF DESCRIPTION OF THE DRAWINGS

The foregoing and other aspects of the present invention are best understood from the following detailed description when read in connection with the accompanying drawings. For the purpose of illustrating the invention, there is shown in the drawings embodiments that are presently preferred, it being understood, however, that the invention is not limited to the specific instrumentalities disclosed. Included in the drawings are the following Figures:

FIG. 1 depicts a schematic diagram of one illustrative embodiment of a cognitive system implementing a type-specific answer filtration system in a computer network;

FIG. 2 is a block diagram of an example data processing system in which aspects of the illustrative embodiments may be implemented;

FIG. 3 illustrates a workflow diagram depicting the function of a type-specific answer filtration system, according to embodiments described herein; and

FIG. 4 illustrates a flowchart diagram depicting the function of a type-specific answer filtration system, according to embodiments described herein.

### DETAILED DESCRIPTION OF EXEMPLARY EMBODIMENTS

The system and method described herein can be used as a component of a deep question answering system, and can identify what subtype of numerical answer would be an appropriate answer to a question (e.g., a currency values, a measure of length, a weight values), while filtering out candidate answers that are not of that subtype. The system and method can improve accuracy and thus reduce implausible answers for the important subclass of number questions. The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a head disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network (LAN), a wide area network (WAN), and/or a wireless network. The network may comprise copper transmission cables, optical transmission fibers, wireless transmission, routers, firewalls, switches, gateway computers, and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object-oriented programming language such as Java, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer, or entirely on the remote computer or server. In the latter scenario, the remote computer may be connected to the user's computer through any type of network, including LAN or WAN, or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operations steps to be performed on the computer, other programmable apparatus, or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical functions. In some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

As an overview, a cognitive system is a specialized computer system, or set of computer systems, configured with hardware and/or software logic (in combination with hardware logic upon which the software executes) to emulate human cognitive functions. These cognitive systems apply human-like characteristics to conveying and manipulating ideas which, when combined with the inherent strengths of digital computing, can solve problems with high accuracy and resilience on a large scale. IBM Watson™ is an example of one such cognitive system which can process human readable language and identify inferences between text passages with human-like accuracy at speeds far faster than human beings and on a much larger scale. In general, such cognitive systems are able to perform the following functions:
Navigate the complexities of human language and understanding
Ingest and process vast amounts of structured and unstructured data
Generate and evaluate hypotheses
Weigh and evaluate responses that are based only on relevant evidence
Provide situation-specific advice, insights, and guidance
Improve knowledge and learn with each iteration and interaction through machine learning processes
Enable decision making at the point of impact (contextual guidance)
Scale in proportion to the task
Extend and magnify human expertise and cognition
Identify resonating, human-like attributes, and traits from natural language
Deduce various language specific or agnostic attributes from natural language
High degree of relevant recollection from data points (images, text, voice) (memorization and recall)
Predict and sense with situation awareness that mimic human cognition based on experiences
Answer questions based on natural language and specific evidence

In one aspect, cognitive systems provide mechanisms for answering questions posed to these cognitive systems using a Question Answering pipeline or system (QA system). The QA system pipeline or system is an artificial intelligence application executing on data processing hardware that answers questions pertaining to a given subject-matter domain presented in natural language. The QA system pipeline receives inputs from various sources including input over a network, a corpus of electronic documents or other data, data from a content creator, information from one or more content users, and other such inputs from other possible sources of input. Data storage devices store the corpus of data. A content creator creates content in a document for use as part of a corpus of data with the QA system pipeline. The document may include any file, text, article, or source of data for use in the QA system. For example, a QA system pipeline accesses a body of knowledge about the domain, or subject matter area (e.g., financial domain, medical domain, legal domain, etc.) where the body of knowledge (knowledgebase) can be organized in a variety of configurations, e.g., a structured repository of domain-specific information, such as ontologies, or unstructured data related to the domain, or a collection of natural language documents about the domain.

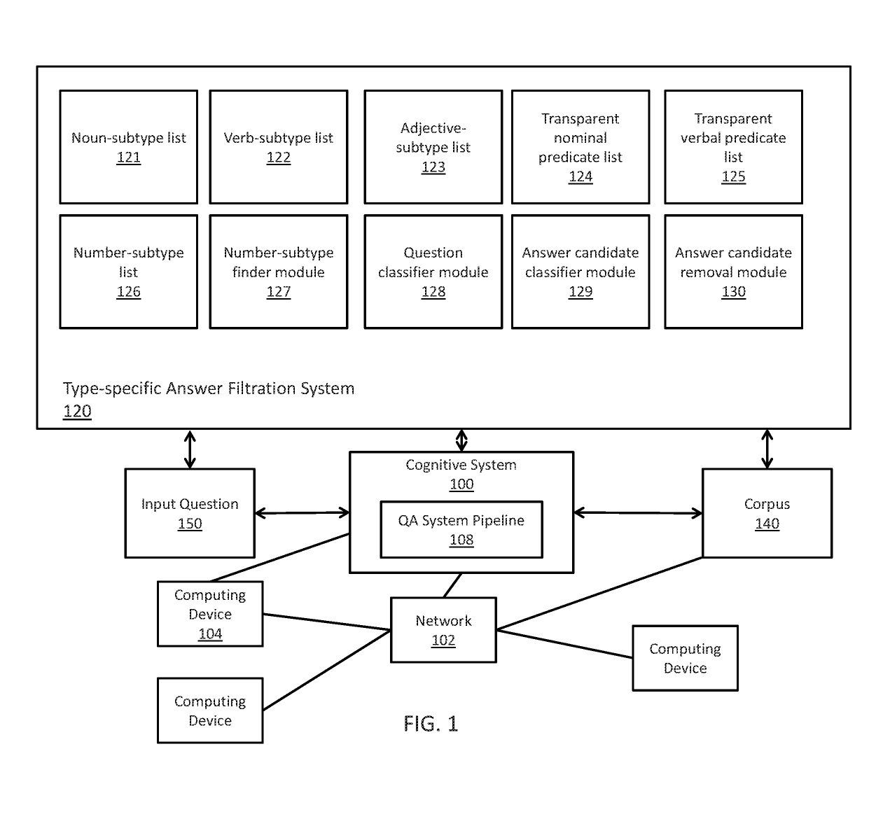

FIG. 1 depicts a schematic diagram of one illustrative embodiment of a cognitive system 100 implementing a question and answer (QA) pipeline 108 and a type-specific answer filtration system 120 in a computer network 102. One example of a question/answer generation operation which may be used in conjunction with the principles described herein is described in U.S. Patent Application Publication No. 2011/0125734, which is herein incorporated by reference in its entirety. The cognitive system 100 is implemented on one or more computing devices 104 (comprising one or more processors and one or more memories, and potentially any other computing device elements generally known in the art including buses, storage devices, communication interfaces, and the like) connected to the computer network 102. The network 102 includes multiple computing devices 104 in communication with each other and with other devices or components via one or more wired and/or wireless data communication links, where each communication link comprises one or more of wires, routers, switches, transmitters, receivers, or the like. The cognitive system 100 and network 102 enables type-specific answer filtration functionality for one or more cognitive system users via their respective computing devices. Other embodiments of the cognitive system 100 may be used with components, systems, sub-systems, and/or devices other than those that are depicted herein.

The cognitive system 100 is configured to implement a QA system pipeline 108 that receive inputs from various sources. For example, the cognitive system 100 receives input from the network 102, a corpus of electronic documents 140, cognitive system users, and/or other data and other possible sources of input. In one embodiment, some or all of the inputs to the cognitive system 100 are routed through the network 102. The various computing devices 104 on the network 102 include access points for content creators and QA system users. Some of the computing devices 104 include devices for a database storing the corpus of data 140. Portions of the corpus of data 140 may also be provided on one or more other network attached storage devices, in one or more databases, or other computing devices not explicitly shown in FIG. 1. The network 102 includes local network connections and remote connections in various embodiments, such that the cognitive system 100 may operate in environments of any size, including local and global, e.g., the Internet.

In one embodiment, the content creator creates content in a document of the corpus of data 140 for use as part of a corpus of data with the cognitive system 100. The document includes any file, text, article, or source of data for use in the cognitive system 100. QA system users access the cognitive system 100 via a network connection or an Internet connection to the network 102, and input questions to the cognitive system 100 that are answered by the content in the corpus of data 140. The cognitive system 100 parses and interprets a search query via a QA system pipeline 108, and provides a response containing one or more answers to the question. In an embodiment, an improved response can be obtained from the QA system using the type specific answer filtration system 120 described herein. In some embodiments, the cognitive system 100 provides a response to users in a ranked list of candidate answers while in other illustrative embodiments, the cognitive system 100 provides a single final answer or a combination of a final answer and ranked listing of other candidate answers.

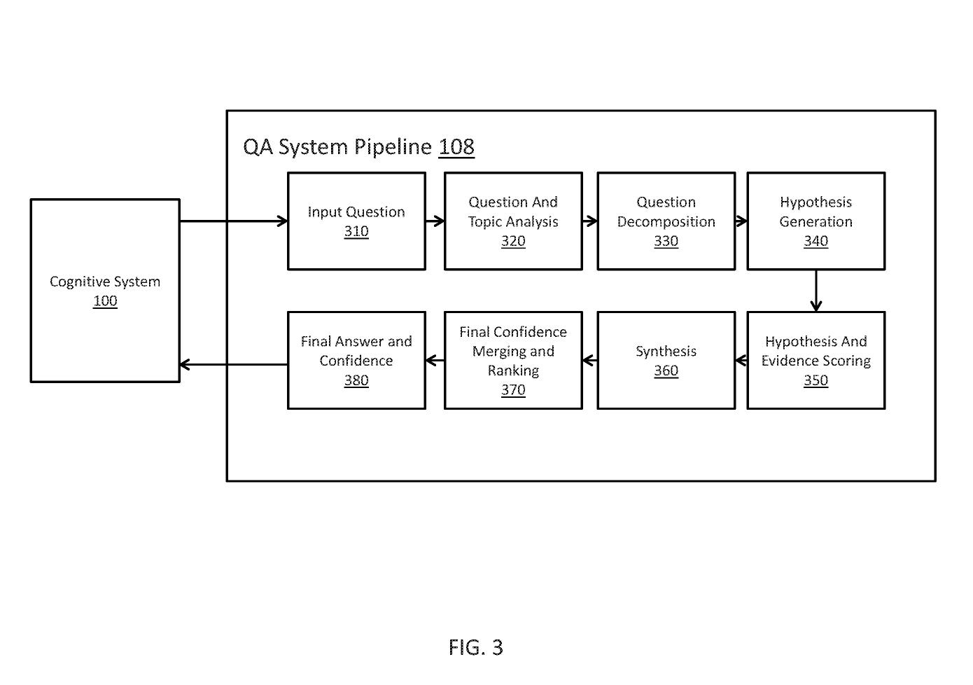

The cognitive system 100 implements the QA system pipeline 108 which comprises a plurality of stages for processing an input question and the corpus of data 140. The QA system pipeline 108 generates answers for the input question based on the processing of the input question and the corpus of data 140. The QA system pipeline 108 will be described in greater detail hereafter with regard to FIG. 3.

In some illustrative embodiments, the cognitive system 100 may be the IBM Watson™ cognitive system available from International Business Machines Corporation of Armonk, N.Y., which is augmented with the mechanisms of the illustrative embodiments described hereafter. As outlined previously, a QA system pipeline of the IBM Watson™ cognitive system receives an input question, which it then parses to extract the major features of the question, and which in turn are then used to formulate queries that are applied to the corpus of data. Based on the application of the queries to the corpus of data, a set of hypotheses, or candidate answers to the input question, are generated by looking across the corpus of data for portions of the corpus of data that have some potential for containing a valuable response to the input question. The QA system pipeline of the IBM Watson™ cognitive system then performs deep analysis on the language of the input question (which can include determination of a numeric subtype of the question by answer filtration system 120) and the language used in each of the portions of the corpus of data found during the application of the queries using a variety of reasoning algorithms. The scores obtained from the various reasoning algorithms are then weighted against a statistical model that summarizes a level of confidence that the QA system pipeline of the IBM Watson™ cognitive system has regarding the evidence that the potential response, i.e., candidate answer, is inferred by the question. This process is repeated for each of the candidate answers to generate a ranked listing of candidate answers which may then be presented to the user that submitted the input question, or from which a final answer is selected and presented to the user. More information about the QA system pipeline of the IBM Watson™ cognitive system may be obtained, for example, from the IBM Corporation website, IBM Redbooks, and the like. For example, information about the QA system pipeline of the IBM Watson™ cognitive system can be found in Yuan et al., “Watson and Healthcare,” IBM developerWorks, 2011 and “The Era of Cognitive Systems: An Inside Look at IBM Watson™ and How it Works” by Rob High, IBM Redbooks, 2012.

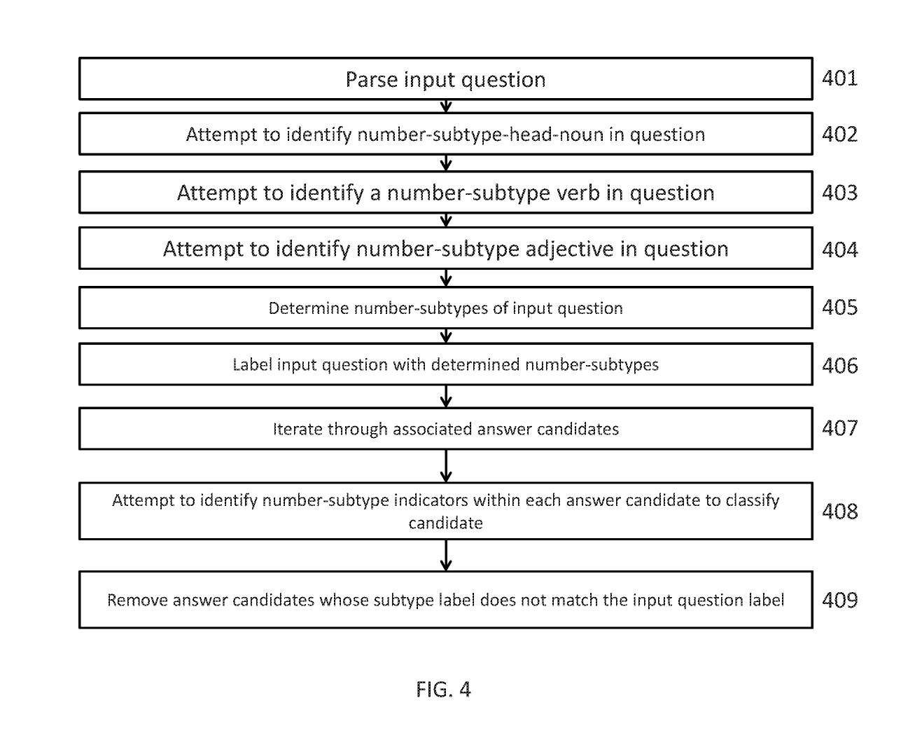

As shown in FIG. 1, in accordance with some illustrative embodiments, the cognitive system 100 is further augmented, in accordance with the mechanisms of the illustrative embodiments, to include logic implemented in specialized hardware, software executed on hardware, or any combination of specialized hardware and software executed on hardware, for implementing a type-specific answer filtration system 120. As described further in FIG. 4, the type-specific answer filtration system 120 can receive one or more input questions 150 from the cognitive system 100. The type-specific answer filtration system 120 can filter proper answer candidates of the input question 150 through the use of the components on the type-specific answer filtration system 120. Components can include noun-subtype lists 121, verb-subtype lists 122, and adjective-subtype lists 123. These lists can be pre-populated lists that contain relationship data matching answer subtypes to identified nouns, verbs, and adjectives, respectively. Additionally, the system 120 can use a transparent nominal predicate list 124 and a transparent verbal predicate list 125, which can be prepopulated lists containing set members corresponding to transparent nominal predicates and transparent verbal predicates. Additionally, the system 120 can use a number-subtype list 126, which can be a prepopulated list that matches numerical identifiers with particular subtypes. To filter answer candidates, the system 120 can utilize a number-subtype finder module 127, a question classifier module 128, an answer candidate classifier module 129, and an answer candidate removal module 130. The modules can be implemented in software, hardware, or a combination thereof.

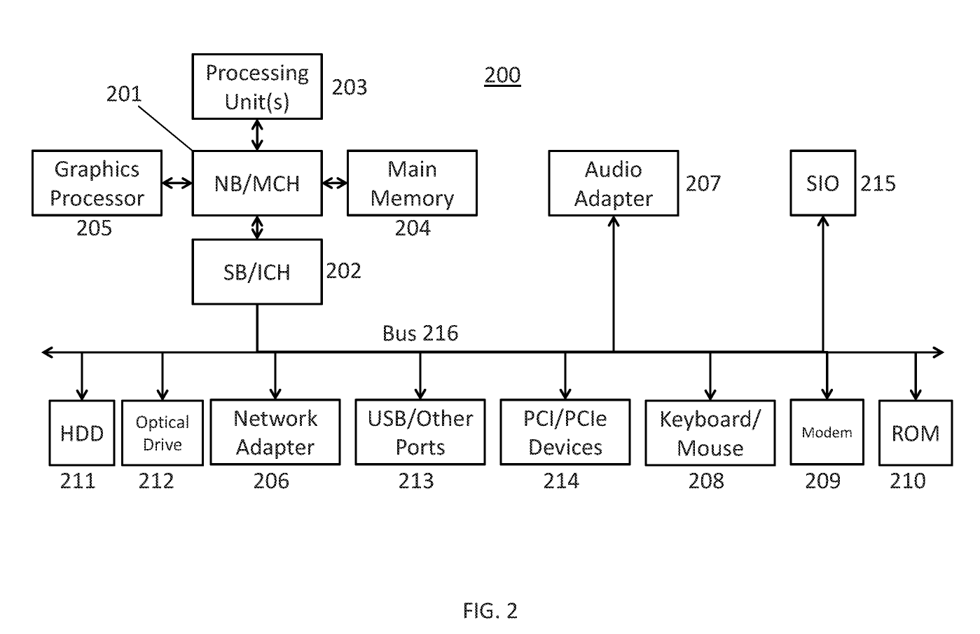

FIG. 2 is a block diagram of an example data processing system 200 in which aspects of the illustrative embodiments are implemented. Data processing system 200 is an example of a computer, such as a server or client, in which computer usable code or instructions implementing the process for illustrative embodiments of the present invention are located. In one embodiment, FIG. 2 represents a server computing device, such as a server, which implements the type-specific answer filtration system 120 and cognitive system 100 described herein.

In the depicted example, data processing system 200 can employ a hub architecture including a north bridge and memory controller hub (NB/MCH) 201 and south bridge and input/output (I/O) controller hub (SB/ICH) 202. Processing unit 203, main memory 204, and graphics processor 205 can be connected to the NB/MCH 201. Graphics processor 205 can be connected to the NB/MCH through an accelerated graphics port (AGP).

In the depicted example, the network adapter 206 connects to the SB/ICH 202. The audio adapter 207, keyboard and mouse adapter 208, modem 209, read only memory (ROM) 210, hard disk drive (HDD) 211, optical drive (CD or DVD) 212, universal serial bus (USB) ports and other communication ports 213, and the PCI/PCIe devices 214 can connect to the SB/ICH 202 through bus system 216. PCI/PCIe devices 214 may include Ethernet adapters, add-in cards, and PC cards for notebook computers. ROM 210 may be, for example, a flash basic input/output system (BIOS). The HDD 211 and optical drive 212 can use an integrated drive electronics (IDE) or serial advanced technology attachment (SATA) interface. The super I/O (SIO) device 215 can be connected to the SB/ICH 202.

An operating system can run on processing unit 203. The operating system can coordinate and provide control of various components within the data processing system 200. As a client, the operating system can be a commercially available operating system. An object-oriented programming system, such as the Java™ programming system, may run in conjunction with the operating system and provide calls to the operating system from the object-oriented programs or applications executing on the data processing system 200. As a server, the data processing system 200 can be an IBM® eServer™ System p® running the Advanced Interactive Executive operating system or the Linux operating system. The data processing system 200 can be a symmetric multiprocessor (SMP) system that can include a plurality of processors in the processing unit 203. Alternatively, a single processor system may be employed.

Instructions for the operating system, the object-oriented programming system, and applications or programs are located on storage devices, such as the HDD 211, and are loaded into the main memory 204 for execution by the processing unit 203. The processes for embodiments of the type-specific answer filtration system can be performed by the processing unit 203 using computer usable program code, which can be located in a memory such as, for example, main memory 204, ROM 210, or in one or more peripheral devices.

A bus system 216 can be comprised of one or more busses. The bus system 216 can be implemented using any type of communication fabric or architecture that can provide for a transfer of data between different components or devices attached to the fabric or architecture. A communication unit such as the modem 209 or network adapter 206 can include one or more devices that can be used to transmit and receive data.

Those of ordinary skill in the art will appreciate that the hardware depicted in FIG. 2 may vary depending on the implementation. Other internal hardware or peripheral devices, such as flash memory, equivalent non-volatile memory, or optical disk drives may be used in addition to or in place of the hardware depicted. Moreover, the data processing system 200 can take the form of any of a number of different data processing systems, including but not limited to, client computing devices, server computing devices, tablet computers, laptop computers, telephone or other communication devices, personal digital assistants, and the like. Essentially, data processing system 200 can be any known or later developed data processing system without architectural limitation.

FIG. 3 illustrates a QA system pipeline, of a cognitive system, for processing an input question in accordance with one illustrative embodiment. The QA system pipeline of FIG. 3 may be implemented, for example, as QA system pipeline 108 of cognitive system 100 in FIG. 1. It should be appreciated that the stages of the QA system pipeline shown in FIG. 3 are implemented as one or more software engines, components, or the like, which are configured with logic for implementing the functionality attributed to the particular stage. Each stage is implemented using one or more of such software engines, components, or the like. The software engines, components, etc., are executed on one or more processors of one or more data processing systems or devices and utilize or operate on data stored in one or more data storage devices, memories, or the like, on one or more of the data processing systems. The QA system pipeline of FIG. 3 is augmented, for example, in one or more of the stages to implement the improved mechanism of the illustrative embodiments described hereafter, additional stages may be provided to implement the improved mechanism, or separate logic from the pipeline 108 may be provided for interfacing with the pipeline 108 and implementing the improved functionality and operations of the illustrative embodiments.

As shown in FIG. 3, the QA system pipeline 108 comprises a plurality of stages 310-380 through which the cognitive system operates to analyze an input question and generate a final response. In an initial input question stage 310, the QA system pipeline 108 receives an input question (e.g., 150 as shown in FIG. 1) that is presented in a natural language format. That is, a user inputs, via a user interface, an input question for which the user wishes to obtain an answer, e.g., “Who are Washington's closest advisors?” Alternatively, the improved search query generation system can input an improved search query generated by the system. In response to receiving the input question, the next stage of the QA system pipeline 108, i.e., the question and topic analysis stage 320, parses the input question using natural language processing (NLP) techniques to extract major features from the input question, and classify the major features according to types, e.g., names, dates, or any of a plethora of other defined topics. For example, in the example question above, the term “who” may be associated with a topic for “persons” indicating that the identity of a person is being sought, “Washington” may be identified as a proper name of a person with which the question is associated, “closest” may be identified as a word indicative of proximity or relationship, and “advisors” may be indicative of a noun or other language topic.

In addition, the extracted major features include key words and phrases classified into question characteristics, such as the focus of the question, the lexical answer type (LAT) of the question, and the like. As referenced to herein, a lexical answer type (LAT) is a word in, or a word inferred from, the input question that indicates the type of the answer, independent of assigning semantics to that word. For example, in the question “What maneuver was invented in the 1500s to speed up the game and involves two pieces of the same color?” the LAT is the string “maneuver.” The focus of a question is the part of the question that, if replaced by the answer, makes the question a standalone statement. For example, in the question “What drug has been shown to relieve the symptoms of ADD with relatively few side effects?,” the focus is “drug” since if this word were replaced with the answer, e.g., “Adderall,” the answer can be used to replace the term “drug” to generate the sentence “Adderall has been shown to relieve the symptoms of ADD with relatively few side effects.” The focus often, but not always, contains the LAT. On the other hand, in many cases it is not possible to infer a meaningful LAT from the focus.

Referring again to FIG. 3, the identified major features are then used during the question decomposition stage 330 to decompose the question into one or more queries that are applied to the corpora of data/information in order to generate one or more hypotheses. The queries are generated in any known or later developed query language, such as the Structure Query Language (SQL), or the like. The queries are applied to one or more databases storing information about the electronic texts, documents, articles, websites, and the like, that make up the corpora of data/information. That is, these various sources themselves, different collections of sources, and the like, represent a different corpus within the corpora. There may be different corpora defined for different collections of documents based on various criteria depending upon the particular implementation. For example, different corpora may be established for different topics, subject matter categories, sources of information, or the like. As one example, a first corpus may be associated with healthcare documents while a second corpus may be associated with financial documents. Alternatively, one corpus may be documents published by the U.S. Department of Energy while another corpus may be IBM Redbooks documents. Any collection of content having some similar attribute may be considered to be a corpus within the corpora.

The queries are applied to one or more databases storing information about the electronic texts, documents, articles, websites, and the like, that make up the corpus of data/information, e.g., the corpus of data 140 in FIG. 1. The queries are applied to the corpus of data/information at the hypothesis generation stage 340 to generate results identifying potential hypotheses for answering the input question, which can then be evaluated. That is, the application of the queries results in the extraction of portions of the corpus of data/information matching the criteria of the particular query. These portions of the corpus are then analyzed and used, during the hypothesis generation stage 340, to generate hypotheses for answering the input question. These hypotheses are also referred to herein as “candidate answers” for the input question. For any input question, at this stage 340, there may be hundreds of hypotheses or candidate answers generated that may need to be evaluated.

The QA system pipeline 108, in stage 350, then performs a deep analysis and comparison of the language of the input question and the language of each hypothesis or “candidate answer,” as well as performs evidence scoring to evaluate the likelihood that the particular hypothesis is a correct answer for the input question. As described in FIG. 1, this involves using a plurality of reasoning algorithms, each performing a separate type of analysis of the language of the input question and/or content of the corpus that provides evidence in support of, or not in support of, the hypothesis. Each reasoning algorithm generates a score based on the analysis it performs which indicates a measure of relevance of the individual portions of the corpus of data/information extracted by application of the queries as well as a measure of the correctness of the corresponding hypothesis, i.e., a measure of confidence in the hypothesis. There are various ways of generating such scores depending upon the particular analysis being performed. In general, however, these algorithms look for particular terms, phrases, or patterns of text that are indicative of terms, phrases, or patterns of interest and determine a degree of matching with higher degrees of matching being given relatively higher scores than lower degrees of matching.

In the synthesis stage 360, the large number of scores generated by the various reasoning algorithms are synthesized into confidence scores or confidence measures for the various hypotheses. This process involves applying weights to the various scores, where the weights have been determined through training of the statistical model employed by the QA system pipeline 108 and/or dynamically updated. For example, the weights for scores generated by algorithms that identify exactly matching terms and synonyms may be set relatively higher than other algorithms that are evaluating publication dates for evidence passages. The weights themselves may be specified by subject matter experts or learned through machine learning processes that evaluate the significance of characteristics evidence passages and their relative importance to overall candidate answer generation.

The weighted scores are processed in accordance with a statistical model generated through training of the QA system pipeline 108 that identifies a manner by which these scores may be combined to generate a confidence score or measure for the individual hypotheses or candidate answers. This confidence score or measure summarizes the level of confidence that the QA system pipeline 108 has about the evidence that the candidate answer is inferred by the input question, i.e., that the candidate answer is the correct answer for the input question.

The resulting confidence scores or measures are processed by a final confidence merging and ranking stage 370 which compares the confidence scores and measures to each other, compares them against predetermined thresholds, or performs any other analysis on the confidence scores to determine which hypotheses/candidate answers are the most likely to be the correct answer to the input question. The hypotheses/candidate answers are ranked according to these comparisons to generate a ranked listing of hypotheses/candidate answers (hereafter simply referred to as “candidate answers”). From the ranked listing of candidate answers, at stage 380, a final answer and confidence score, or final set of candidate answers and confidence scores, are generated and output to the submitter of the original input question via a graphical user interface or other mechanism for outputting information.

FIG. 4 illustrates a flowchart depicting the functionality of a type-specific answer filtration system, according to embodiments described herein. First, the type-specific answer filtration will parse an input question into its component syntactic pieces 401. This can involve creating an input question parse tree that maps the component syntactic pieces according to their grammatical structure. Alternate methods of parsing the structure of the input question can be used, so long as the constituent components of the input question are identified. The system can then attempt to identify a number-subtype head-noun in the input question 402, using, for example, the number-subtype finder module (127 as shown in FIG. 1). Identifying a number-subtype head-noun in the input question 402 can involve identifying an element within the input question parse tree (or other question analysis structure), and attempting to match its content to the externally defined list of number-subtype-related nouns (see e.g., 121 as shown in FIG. 1).

The number-subtype head-noun element can be the LAT (“What price did AT&T pay to acquire DirecTV?” or “What was the price that AT&T paid to acquire DirecTV?”), the non-LAT head-noun of a Wh-noun-phrase (“How much money did AT&T pay to acquire DirecTV?”), or a subordinate noun to a transparent nominal predicate, which can be derived, for example, from the transparent nominal predicate list (see e.g., 124 as shown in FIG. 1). Transparent nominal predicates can be elements like “amount” that can take different subtypes of nouns as their grammatical compliments (“What [amount] of money?” vs “What [amount] of water?”, or “What was the [amount] of money?” vs “What was the [amount] of water?”). Additionally, the number-subtype head-noun can be a noun that is the compliment of a prepositional phrase, which can typically be within the focus of a question (“[How much of global clean energy investment] did the Latin American region capture?”), or a noun that is the argument to a verb (“How high did Saudi Arabia raise the price of oil?”).

The system can then attempt to identify a number-subtype verb in the input question 403, using, for example, the number-subtype finder module (see e.g., 127 as shown in FIG. 1). Like identifying a head-noun, identifying a number-subtype verb in the input question 403 can involve identifying a verbal element within the question parse tree (or other question analysis structure), and then attempting to match the verbal element's content to an externally defined list of number-subtype-related verbs (see e.g., 122 as shown in FIG. 1). The number-subtype-verb can be the root verb of the input question (“What did AT&T pay for DirecTV?”) or can be a subordinate verb underneath a transparent verbal predicate (“How much did AT&T [agree] to pay for DirecTV?”), which can be derived from, for example, the transparent verbal predicate list (see e.g., 125 as shown in FIG. 1). Transparent verbal predicates can be verbal elements like “agree” that can take different subtypes of verbs as their grammatical compliments.

The system can then attempt to identify a number-subtype adjective in the input question 404, using, for example, the number-subtype finder module (see e.g., 127 as shown in FIG. 1). Like identifying a head-noun or number-subtype verb, identifying a number-subtype adjective in the input question 404 can involve identifying an adjectival element within the question parse tree (or other question analysis structure), and attempting to match its content to an externally defined list of number-subtype-related adjectives (see e.g., 123 as shown in FIG. 1). The number-subtype adjective can be the head adjective of the input question phrase (“How expensive was DirecTV for AT&T?”).

Based on whether the system is able to identify one or more number-subtype determining head-noun, verb, and/or adjective, the system can then determine the appropriate number-subtypes of the question 405 and label the input question with those determined number-subtypes 406, using, for example, the question classifier module (see e.g., 128 as shown in FIG. 1). The set of compatible number-subtypes can be determined based upon mappings of the head-noun, verb, and/or adjective, which can encode the interaction of the various factors as they relate to number-subtypes. The set of possible number-subtypes from which compatible number-subtypes can be derived can originate with a number-subtype list (see e.g., 126 as shown in FIG. 1), which can be previously populated prior to initiation of the system.

For example, in the question “How high did Saudi Arabia raise the price of oil?,” the word “high” can denote money or length, the word “price” can denote money, and the word “raise” can also denote money or length. As the common mapping is money, the overall input question number-subtype can be labeled as money. In the question “How long did Mark Kelly spend in the International Space Station?,” the word “long” can denote duration or length, while the word “spend” can denote duration or money. As the common mapping is duration, the overall input question number-subtype can be labeled as duration. In the question, “How high did Arctic ice melting raise the level of the ocean?,” the word “high” can denote length or temperature, the word “level” can denote length, and the word “raise” can denote money or length. As the common mapping is length, the overall input question number-subtype can be labeled as length.

Once the input question's number-subtype has been determined 405 and labeled 406, the system can iterate through the associated answer candidates of the input question 407, which are derived from the question answering system 108 embodied in the cognitive system 100. For each answer candidate, the system can attempt to identify number-subtype indicators within the answer candidate in order to classify the answer candidate 408, using, for example, the answer candidate classifier module (see e.g., 129 as shown in FIG. 1). For example, if the answer candidate contains a dollar sign, USD, EUR, dollars, etc., the system can identify the number-subtype of the answer candidate as relating to money. If the answer candidate contains feet, km, miles, inches, etc., the system can identify the number-subtype of the answer candidate as relating to length. If the answer contains lb., kg, pounds, grams, etc., the system can identify the number-subtype of the answer candidate as relating to weight. Similar determinations can be made for all number-subtypes. Finally, the system can remove answer candidates whose number-subtype label does not match the input question number-subtype label 409, using, for example, the answer candidate removal module (see e.g., 130 as shown in FIG. 1). This ensures that improper form answers are not expressed by the system when the particular question is asked.

The present description and claims may make use of the terms “a,” “at least one of,” and “one or more of,” with regard to particular features and elements of the illustrative embodiments. It should be appreciated that these terms and phrases are intended to state that there is at least one of the particular feature or element present in the particular illustrative embodiment, but that more than one can also be present. That is, these terms/phrases are not intended to limit the description or claims to a single feature/element being present or require that a plurality of such features/elements be present. To the contrary, these terms/phrases only require at least a single feature/element with the possibility of a plurality of such features/elements being within the scope of the description and claims.

In addition, it should be appreciated that the following description uses a plurality of various examples for various elements of the illustrative embodiments to further illustrate example implementations of the illustrative embodiments and to aid in the understanding of the mechanisms of the illustrative embodiments. These examples are intended to be non-limiting and are not exhaustive of the various possibilities for implementing the mechanisms of the illustrative embodiments. It will be apparent to those of ordinary skill in the art in view of the present description that there are many other alternative implementations for these various elements that may be utilized in addition to, or in replacement of, the example provided herein without departing from the spirit and scope of the present invention.

The system and processes of the figures are not exclusive. Other systems, processes and menus may be derived in accordance with the principles of embodiments described herein to accomplish the same objectives. It is to be understood that the embodiments and variations shown and described herein are for illustration purposes only. Modifications to the current design may be implemented by those skilled in the art, without departing from the scope of the embodiments. As described herein, the various systems, subsystems, agents, managers, and processes can be implemented using hardware components, software components, and/or combinations thereof. No claim element herein is to be construed under the provisions of 35 U.S.C. 112, sixth paragraph, unless the element is expressly recited using the phrase “means for.”

Although the invention has been described with reference to exemplary embodiments, it is not limited thereto. Those skilled in the art will appreciate that numerous changes and modifications may be made to the preferred embodiments of the invention and that such changes and modifications may be made without departing from the true spirit of the invention. It is therefore intended that the appended claims be construed to cover all such equivalent variations as fall within the true spirit and scope of the invention.

What is claimed is:

1. A computer implemented method in a data processing system comprising a processor and a memory comprising instructions which are executed by the processor to cause the processor to implement a type-specific answer filtration system, the method comprising:
parsing, by the processor, one or more input questions;
for each input question:
attempting, by a number-subtype finder module, to identify one or more number-subtype head-nouns;
attempting, by a number-subtype finder module, to identify one or more number-subtype verbs;
attempting, by a number-subtype finder module, to identify one or more number-subtype adjectives;
based on the presence of at least one number-subtype head-noun, number-subtype verb, or number-subtype adjective, determining, by a question classifier module, the number-subtype of the input questions;
labelling the input question with the determined number-subtype;
iterating through one or more answer candidates associated with the input question;
for each answer candidate, determining, by an answer candidate classifier module, the number-subtype of the answer candidate; and
if the answer candidate number-subtype does not match the input question number-subtype, removing, by an answer candidate removal module, the answer candidate.

2. The method as recited in claim 1, further comprising:
attempting to identify one or more number-subtype head nouns from at least one of the lexical answer type, the non-lexical answer type head-noun of a Wh-noun-phrase, a subordinate noun to a transparent nominal predicate, a noun complemental of a prepositional phrase, or a noun that is an argument to a verb.

3. The method as recited in claim 2, further comprising:
attempting to identify one or more number-subtype head-nouns using a prepopulated list of noun-subtypes.

4. The method as recited in claim 1, further comprising:
attempting to identify the one or more number subtype verbs from at least one of a root verb of the input question or a subordinate verb underneath a transparent verbal predicate.

5. The method as recited in claim 4, further comprising:
attempting to identify the one or more number-subtype verbs using a prepopulated list of verb-subtypes.

6. The method as recited in claim 1, further comprising:
attempting to identify one or more number-subtype adjectives using a prepopulated list of adjective-subtypes.

7. The method as recited in claim 1, further comprising:
determining a set of compatible number-subtypes based upon one or more mappings of at least one of the identified head-noun, identified verb, or identified adjective.

8. A computer program product for type-specific answer filtration, the computer program product comprising a computer readable storage medium having program instructions embodied therewith, the program instructions executable by a processor to cause the processor to:
parse, by the processor, one or more input questions;
for each input question:
attempt, by a number-subtype finder module, to identify one or more number-subtype head-nouns;
attempt, by a number-subtype finder module, to identify one or more number-subtype verbs;
attempt, by a number-subtype finder module, to identify one or more number-subtype adjectives;
based on the presence of at least one number-subtype head-noun, number-subtype verb, or number-subtype adjective, determine, by a question classifier module, the number-subtype of the input questions;
label the input question with the determined number-subtype;
iterate through one or more answer candidates associated with the input question;
for each answer candidate, determine, by an answer candidate classifier module, the number-subtype of the answer candidate; and
if the answer candidate number-subtype does not match the input question number-subtype, remove, by an answer candidate removal module, the answer candidate.

9. The computer program product as recited in claim 8, wherein the processor is further caused to:
attempt to identify one or more number-subtype head nouns from at least one of the lexical answer type, the non-lexical answer type head-noun of a Wh-noun-phrase, a subordinate noun to a transparent nominal predicate, a noun complemental of a prepositional phrase, or a noun that is an argument to a verb.

10. The computer program product as recited in claim 9, wherein the processor is further caused to:
attempt to identify one or more number-subtype head-nouns using a prepopulated list of noun-subtypes.

11. The computer program product as recited in claim 8, wherein the processor is further caused to:
attempt to identify the one or more number subtype verbs from at least one of a root verb of the input question or a subordinate verb underneath a transparent verbal predicate.

12. The computer program product as recited in claim 11, wherein the processor is further caused to:
attempt to identify the one or more number-subtype verbs using a prepopulated list of verb-subtypes.

13. The computer program product as recited in claim 8, wherein the processor is further caused to:
attempt to identify one or more number-subtype adjectives using a prepopulated list of adjective-subtypes.

14. The computer program product as recited in claim 8, wherein the processor is further caused to:
determine a set of compatible number-subtypes based upon one or more mappings of at least one of the identified head-noun, identified verb, or identified adjective.

15. A system for type-specific answer filtration, comprising:
a type-specific answer filtration processor configured to:
parse, by the processor, one or more input questions;
for each input question:
attempt, by a number-subtype finder module, to identify one or more number-subtype head-nouns;
attempt, by a number-subtype finder module, to identify one or more number-subtype verbs;
attempt, by a number-subtype finder module, to identify one or more number-subtype adjectives;
based on the presence of at least one number-subtype head-noun, number-subtype verb, or number-subtype adjective, determine, by a question classifier module, the number-subtype of the input questions;
label the input question with the determined number-subtype;
iterate through one or more answer candidates associated with the input question;
for each answer candidate, determine, by an answer candidate classifier module, the number-subtype of the answer candidate; and
if the answer candidate number-subtype does not match the input question number-subtype, remove, by an answer candidate removal module, the answer candidate.

16. The system as recited in claim 15, wherein the type-specific answer filtration processor is further configured to:
attempt to identify one or more number-subtype head nouns from at least one of the lexical answer type, the non-lexical answer type head-noun of a Wh-noun-phrase, a subordinate noun to a transparent nominal predicate, a noun complemental of a prepositional phrase, or a noun that is an argument to a verb.

17. The system as recited in claim 16, wherein the type-specific answer filtration processor is further configured to:
attempt to identify one or more number-subtype head-nouns using a prepopulated list of noun-subtypes.

18. The system as recited in claim 15, wherein the type-specific answer filtration processor is further configured to:
attempt to identify the one or more number subtype verbs from at least one of a root verb of the input question or a subordinate verb underneath a transparent verbal predicate.

19. The system as recited in claim 18, wherein the type-specific answer filtration processor is further configured to:
attempt to identify the one or more number-subtype verbs using a prepopulated list of verb-subtypes.

20. The system as recited in claim 15, wherein the type-specific answer filtration processor is further configured to:
determine a set of compatible number-subtypes based upon one or more mappings of at least one of the identified head-noun, identified verb, or identified adjective.
